(19) United States
(12) Patent Application Publication
(10) Pub. No.: US 2026/0241956 A1
(43) Pub. Date: Aug. 20, 2026

(54) VEHICLE CONTROL APPARATUS AND VEHICLE CONTROL METHOD

(71) Applicant: TOYOTA JIDOSHA KABUSHIKI KAISHA, Toyota-shi (JP)

(72) Inventor: Hiroki FURUTA, Toki-shi (JP)

(73) Assignee: TOYOTA JIDOSHA KABUSHIKI KAISHA, Toyota-shi (JP)

(21) Appl. No.: 19/382,271

(22) Filed: Nov. 7, 2025

(30) Foreign Application Priority Data
Feb. 17, 2025 (JP) 2025-023570

(51) Int. Cl. B60W 60/00; B60W 40/114; B60W 50/00

(52) U.S. Cl. CPC B60W 60/0013; B60W 40/114; B60W 2050/0022; B60W 2710/207; B60W 2720/18

(57) ABSTRACT

A vehicle control apparatus that controls a vehicle behavior control device that is able to control a movement of a vehicle body in a roll direction, the vehicle control apparatus includes an acquisition unit configured to acquire information indicating a roll control gain for moving the vehicle body in the roll direction by driving the vehicle behavior control device, and a calculation unit configured to calculate, when the autonomous driving control is being executed, a target control value to be executed in autonomous driving control based on the information indicating the roll control gain.

### CROSS-REFERENCE TO RELATED APPLICATION

This application claims priority to Japanese Patent Application No. 2025-023570 filed on Feb. 17, 2025. The disclosure of the above-identified application, including the specification, drawings, and claims, is incorporated by reference herein in its entirety.

### BACKGROUND

### 1. Technical Field

The present disclosure relates to a technology for executing autonomous driving control of a vehicle and roll control of a vehicle body.

### 2. Description of Related Art

Japanese Unexamined Patent Application Publication No. 2015-199433 (JP 2015-199433 A) discloses a vehicle turning traveling control apparatus that executes autonomous driving according to a dynamic change characteristic of a turning behavior. The vehicle turning traveling control apparatus defines a relationship between a slip angle of a tire and a lateral force as a reference characteristic curve, and calculates an inclination of a tangent line of the reference characteristic curve at a coordinate position corresponding to the slip angle or the lateral force as a cornering power. Further, a distribution ratio between yaw moment control and deceleration control of the vehicle is set by using the cornering power to realize a target turning behavior of the vehicle.

### SUMMARY

In the technology disclosed in JP 2015-199433 A, the distribution ratio between the yaw moment control and the deceleration control is set by using the cornering power calculated based on the slip angle and the lateral force. However, in a case where roll control of moving a vehicle body in a roll direction by using an active suspension device or the like is executed during turning, a suspension characteristic such as a camber angle may change and the behavior is likely to deviate from the target turning behavior.

An object of the present disclosure is to provide a technology capable of improving driver's comfort by roll control and improving followability to a target trajectory in autonomous driving control.

In order to solve the above problems, an aspect of the present disclosure is a vehicle control apparatus that controls a vehicle behavior control device that is able to control a movement of a vehicle body in a roll direction. The vehicle control apparatus includes: an acquisition unit configured to acquire information indicating a roll control gain for driving the vehicle behavior control device to move the vehicle body in the roll direction; and a calculation unit configured to calculate, when autonomous driving control is being executed, a target control value to be executed in the autonomous driving control based on the information indicating the roll control gain.

Another aspect of the present disclosure is a vehicle control method. The method is a vehicle control method executed by a vehicle control apparatus that controls a vehicle behavior control device that is able to control a movement of a vehicle body in a roll direction. The vehicle control method includes: acquiring information indicating a roll control gain for driving the vehicle behavior control device to move the vehicle body in the roll direction; and calculating, when autonomous driving control is being executed, a target control value to be executed in the autonomous driving control based on the roll control gain that is acquired.

According to the present disclosure, the technology capable of improving the comfort of the driver by the roll control and improving the followability to the target trajectory in the autonomous driving control can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a functional configuration of a vehicle control system of an embodiment;

FIG. 2 is a diagram showing a relationship between a roll control gain and an equivalent cornering power;

FIG. 3 is a diagram showing a relationship between the roll control gain and a delay time constant of a lateral force;

FIG. 4 is a diagram showing a turning state of a vehicle in a two-wheel model; and

FIG. 5 is a flowchart of the vehicle control method of the embodiment.

### DETAILED DESCRIPTION OF EMBODIMENTS

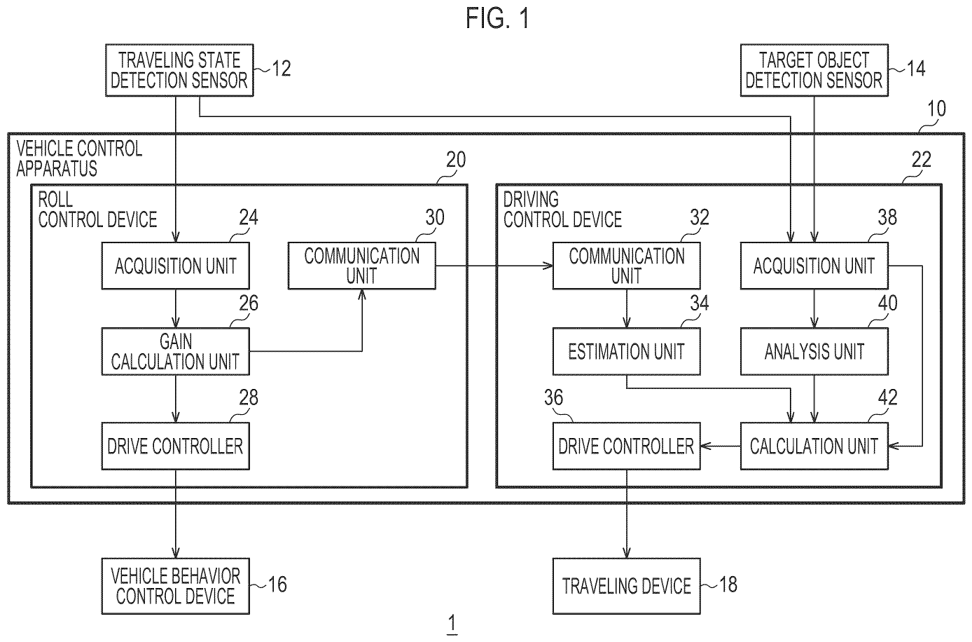

FIG. 1 is a diagram showing a functional configuration of a vehicle control system 1 of an embodiment. In FIG. 1, each of the elements described as functional blocks that perform various types of processing can be configured with a circuit block, a memory, and other LSIs in terms of hardware. In addition, in terms of software, the function is realized by a program or the like loaded in the memory. Therefore, it is understood by those skilled in the art that the functional blocks can be realized in various forms by solely hardware, solely software, or a combination thereof, and are not limited to any of the forms.

The vehicle control system 1 executes autonomous driving control in which the vehicle can be driven autonomously. The vehicle control system 1 executes, in the autonomous driving control, follow control of following a preceding vehicle and cruise control of traveling in a traveling lane at a vehicle speed that is predetermined. The vehicle control system 1 includes a vehicle control apparatus 10, a traveling state detection sensor 12, a target object detection sensor 14, a vehicle behavior control device 16, and a traveling device 18.

The traveling state detection sensor 12 detects a traveling state of the vehicle. The traveling state detection sensor 12 includes a vehicle speed sensor, a steering angle sensor, an acceleration sensor, a brake pressure sensor, and the like, and transmits a result of detecting the traveling state of the vehicle to the vehicle control apparatus 10.

The target object detection sensor 14 includes an in-vehicle camera, a millimeter wave radar, an optical radar, a sound wave sensor, and the like, and detects a target object located around the vehicle. The target object detection sensor 14 may transmit information indicating a positional relationship between the target object and the vehicle as information related to the target object to the vehicle control apparatus 10, or may transmit a mere sensor value as information related to the target object to the vehicle control apparatus 10.

The vehicle behavior control device 16 is, for example, an active stabilizer device. The active stabilizer device may be provided on both a front wheel side and a rear wheel side, or may be provided solely on the front wheel side. The active stabilizer device is connected to right and left wheels, for example, lower arms at both end portions. The active stabilizer device includes a right stabilizer bar, a left stabilizer bar, and an electric actuator that connects the right stabilizer bar and the left stabilizer bar to each other such that the right stabilizer bar and the left stabilizer bar can be relatively rotated. The vehicle control apparatus 10 can apply a force in the roll direction to the vehicle body by driving the electric actuator to relatively rotate the right stabilizer bar and the left stabilizer bar.

In addition, the vehicle behavior control device 16 may be an active suspension device. The active suspension device may be an air suspension device, or a full active suspension device that is electric or hydraulic. The active suspension device can move the vehicle body in the roll direction by displacing one of the right and left wheel sides in a vertical direction. In any case, the vehicle behavior control device 16 controls the movement of the vehicle body in the roll direction.

The traveling device 18 includes a drive unit configured to apply a drive force to wheels and rotate the wheels to cause the vehicle to travel forward, a steering unit configured to steer the wheels, and a braking unit configured to apply a braking force to the wheels. The drive unit may be an engine, a motor, or a combination thereof. The traveling device 18 may be driven by the operation of the driver or may be driven by the autonomous driving control. That is, the autonomous driving control is executed in response to an instruction from the driver.

The vehicle control apparatus 10 includes a roll control device 20 and a driving control device 22. The roll control device 20 executes roll control of controlling the vehicle behavior control device 16 to move the vehicle body in the roll direction. The driving control device 22 drives the traveling device 18 to execute the autonomous driving control. The roll control device 20 and the driving control device 22 can communicate with each other by in-vehicle communication. The roll control device 20 and the driving control device 22 are not limited to being separate electronic control units (ECUs), and may be a single ECU.

The roll control device 20 includes an acquisition unit 24, a gain calculation unit 26, a drive controller 28, and a communication unit 30. The acquisition unit 24 acquires a detection result of the traveling state detection sensor 12. The detection result includes a lateral acceleration of a vehicle body disposed on a sprung mass or a speed of the vehicle body in a roll direction. The speed of the vehicle body in the roll direction may be calculated based on the lateral acceleration. The lateral acceleration is an acceleration in a right and left direction of the vehicle.

The gain calculation unit 26 acquires information indicating a roll control gain for driving the vehicle behavior control device 16 based on the speed of the vehicle body in the roll direction. The information indicating the roll control gain is an index indicating the magnitude with which the vehicle behavior control device 16 moves the vehicle body in the roll direction, and is information indicating the magnitude of the roll control executed by the vehicle behavior control device 16 to suppress the speed of the vehicle body in the roll direction. The information indicating the roll control gain may be a force or a torque absolute value of an actuator of the vehicle behavior control device 16. The information indicating the roll control gain may be a ratio of the lateral acceleration to the force or the torque absolute value of the actuator. The information indicating the roll control gain may be a target roll angle or may be a target roll angle with respect to the lateral acceleration.

The drive controller 28 drives the vehicle behavior control device 16 in accordance with the roll control gain. As a result, the inclination of the vehicle body in the roll direction during turning of the vehicle is suppressed, and a planar motion characteristic is improved. The communication unit 30 periodically transmits the information indicating the roll control gain calculated by the gain calculation unit 26 to the driving control device 22.

The driving control device 22 includes a communication unit 32, an estimation unit 34, a drive controller 36, an acquisition unit 38, an analysis unit 40, and a calculation unit 42. The acquisition unit 38 acquires the detection result of the traveling state detection sensor 12 and the detection result of the target object detection sensor 14. The acquisition unit 38 acquires the destination and the map information from a navigation device and acquires position information of the vehicle calculated by using a global positioning satellite system.

The analysis unit 40 recognizes information related to the target object, for example, the position information of the target object, based on the detection result of the target object detection sensor 14. The analysis unit 40 may identify the target object from a captured image by using a method of a neural network, for example, a method of deep learning. The target object is an obstacle or a roadside installation. The analysis unit 40 recognizes a preceding vehicle for following or a position of a traveling lane, and generates information related to a traveling target. The analysis unit 40 may set a target position and a target yaw angle in the autonomous driving control.

The calculation unit 42 calculates a target control value to be executed in the autonomous driving control such that the vehicle reaches the target position and the target yaw angle based on an acquisition result of the acquisition unit 38 and an analysis result by the analysis unit 40. The target control value includes a target vehicle speed, a target steering angle, a target deceleration, and the like.

When the vehicle behavior control device 16 executes the roll control during steering, the comfort of the occupant is improved, but the turning characteristic is changed due to the change in the suspension characteristic such as a toe angle, a camber angle, and a lateral displacement of the contact point. In addition, a change amount of the turning characteristic is not constant, and is changed by the roll control gain. Therefore, there is a possibility that followability to the target trajectory of the autonomous driving control is likely to vary. In particular, when the vehicle control apparatus 10 executes the roll control during the turning, the vehicle may turn too much and deviate from the target trajectory. Therefore, the vehicle control apparatus 10 of the embodiment adjusts the target control value in the autonomous driving control, particularly the target steering angle, based on the information indicating the roll control gain.

The communication unit 32 acquires the information indicating the roll control gain from the roll control device 20. The estimation unit 34 estimates the turning characteristic of the vehicle in accordance with the roll control gain. The turning characteristic estimated by the estimation unit 34 is based on the suspension characteristic, and may be at least one of the equivalent cornering power of the wheels during the roll control and a delay time constant of the lateral force.

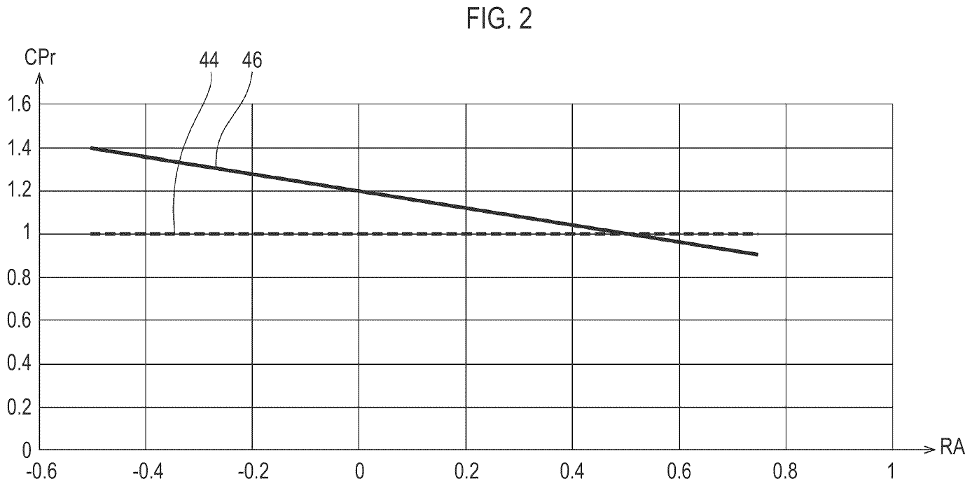

FIG. 2 is a diagram showing a relationship between a roll control gain and an equivalent cornering power. The horizontal axis in FIG. 2 is a roll angle RA as a roll control gain, and a vertical axis in FIG. 2 is an equivalent cornering power ratio CPr.

The roll angle RA is a roll angle RA (the unit is [deg/G]) in accordance with the detected lateral acceleration, and may be a target control value of the vehicle behavior control device 16. The roll angle RA is zero in a horizontal state, and increases as the vehicle body tilts toward the outside of the turn when the vehicle turns. The tilt toward the outside of the turn may be referred to as a positive roll angle.

An equivalent cornering power ratio 44 that is normal is a ratio of the equivalent cornering power when the roll control is not executed to the equivalent cornering power when the roll control is not executed, and is 1. An equivalent cornering power ratio 46 is a ratio of the equivalent cornering power when the roll control is executed to the equivalent cornering power when the roll control is not executed.

The equivalent cornering power ratio 46 indicates that the equivalent cornering power decreases as the roll angle RA increases. That is, when the control for rolling the vehicle body toward the outside of the turn is executed, the equivalent cornering power is reduced, and a grip force of the wheels is reduced. There is no deviation of the equivalent cornering power by the roll control at the roll angle RA at an intersection of the equivalent cornering power ratio 44 and the equivalent cornering power ratio 46.

Information indicating a relationship between a roll angle RA that is a roll control gain and the equivalent cornering power may be stored in advance in the driving control device 22. That is, the estimation unit 34 may estimate the equivalent cornering power of the vehicle behavior control device 16 in accordance with the roll control gain based on a two-dimensional map stored in advance. The relationship is generated by an experiment for each vehicle model or the like. In addition, the estimation unit 34 may estimate the equivalent cornering power in accordance with the roll control gain by using an equation.

The information indicating the relationship between the roll control gain and the equivalent cornering power is a relationship in which the equivalent cornering power decreases as the roll control gain increases the tilt of the vehicle body toward the outside of the turn of the vehicle. Accordingly, the equivalent cornering power that changes in accordance with the roll control gain can be appropriately estimated. When the geometry of the suspension and the tire characteristics are significantly different from those of a general vehicle, the relationship shown in FIG. 2 may not be applied.

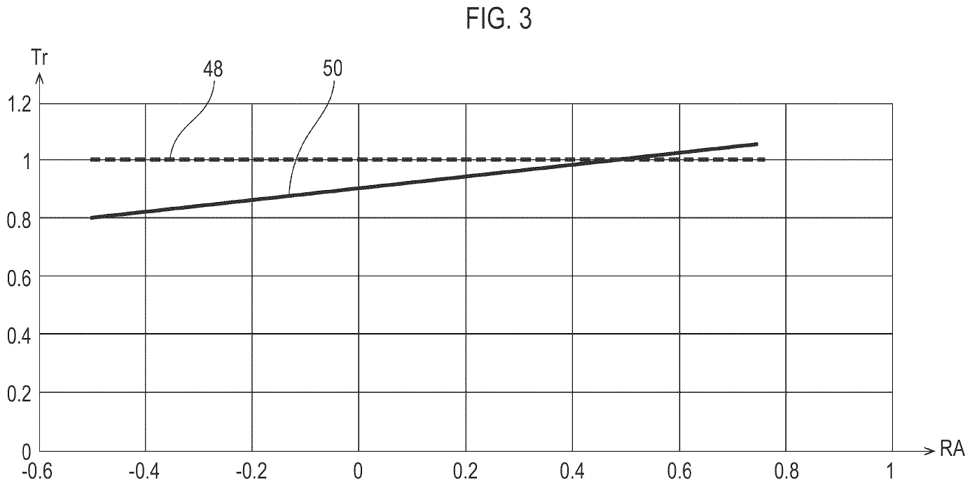

FIG. 3 is a diagram showing a relationship between a roll control gain and a delay time constant of a lateral force. The horizontal axis in FIG. 3 is the same as in FIG. 2, and is the roll angle RA, and the vertical axis in FIG. 3 is a delay time constant ratio Tr of the lateral force. The delay time constant of the lateral force indicates a responsiveness of the lateral force that occurs in the wheels with respect to the slip angle or the steering angle.

A normal delay time constant ratio 48 of the lateral force is a ratio of the delay time constant of the lateral force when the roll control is not executed to the delay time constant of the lateral force when the roll control is not executed, and is 1. The delay time constant ratio 50 of the lateral force is a ratio of the delay time constant of the lateral force when the roll control is executed to the delay time constant of the lateral force when the roll control is not executed.

The delay time constant ratio 50 of the lateral force indicates that the delay time constant of the lateral force increases as the roll angle RA increases. That is, when the control for rolling the vehicle body toward the outside of the turn is executed, the delay time constant of the lateral force is larger than the normal value.

The estimation unit 34 estimates the delay time constant of the lateral force of the vehicle behavior control device 16 in accordance with the roll control gain based on information indicating a relationship between the roll control gain and the delay time constant of the lateral force that is stored in advance. The information indicating the relationship between the roll control gain and the delay time constant of the lateral force may be stored in the driving control device 22 in a format of an equation or a map.

The information indicating the relationship between the roll control gain and the delay time constant of the lateral force is a relationship in which the delay time constant of the lateral force increases as the roll control gain increases the tilt of the vehicle body toward the outside of the turn of the vehicle. Accordingly, the delay time constant of the lateral force that changes in accordance with the roll control gain can be appropriately estimated.

The calculation unit 42 calculates the target control value to be executed in the autonomous driving control based on the estimated turning characteristic of the vehicle. Specifically, the target steering angle to be executed in the autonomous driving control is calculated based on the equivalent cornering power ratio CPr that is estimated and the delay time constant ratio Tr of the lateral force. The calculation unit 42 adjusts the target steering angle executed by the autonomous driving control based on the roll control gain during the vehicle turning and the roll control. As a result, the comfort of the driver can be improved by the roll control, and the followability to the target trajectory in the autonomous driving control can be improved.

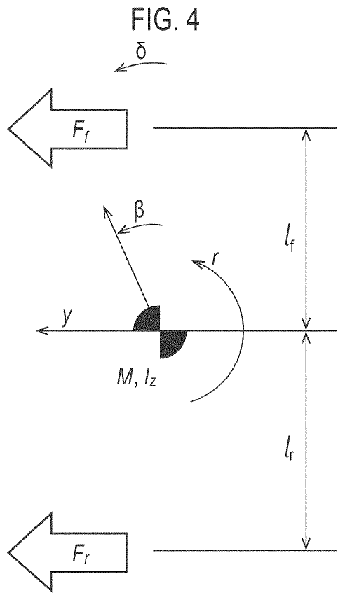

FIG. 4 is a diagram showing a turning state of a vehicle in a two-wheel model.

In the two-wheel model in which the vehicle is simplified, the lateral force F_{f} of the front wheels and the lateral force Fᵣ of the rear wheels are calculated by the following Equations (1) and (2). In the two-wheel model that is simplified, the center of gravity is positioned between one front wheel and one rear wheel.

$${F}_{f} = {C}_{pf} {C}_{cf} ( δ - β - {rl}_{f} / V ) / ( 1 + {T}_{f} {T}_{cf} S ) \qquad Equation ( 1 )$$

C_{pf} is the normal equivalent cornering power of the front wheels, and is a value that is not corrected by C_{cf}. C_{cf} is an equivalent cornering power ratio of the front wheels in accordance with the roll control gain. δ is a steering angle. β is a slip angle. r is a yaw angle at the center of gravity. l_{f} is a distance from the center of gravity to the front wheels, V is a vehicle speed. T_{f} is a normal delay time constant of the lateral force of the front wheels, and is a value that is not corrected by T_{cf}. T_{cf} is a delay time constant ratio of the lateral force of the front wheels in accordance with the roll control gain. S is a Laplace operator set in advance.

$${F}_{r} = {C}_{pr} {C}_{cr} ( δ - β - {rl}_{r} / V ) / ( 1 + {T}_{r} {T}_{cr} S ) \qquad Equation ( 2 )$$

Cₚᵣ is the normal equivalent cornering power of the rear wheels, and is a value that is not corrected by C_{cr}. C_{cr} is an equivalent cornering power ratio of the rear wheels in accordance with the roll control gain. Tᵣ is a normal delay time constant of the lateral force of the rear wheels, and is a value that is not corrected by T_{cr}. T_{cr} is a delay time constant ratio of a lateral force of the rear wheels in accordance with the roll control gain.

By Equations (1) and (2), the lateral force of the wheels corrected by the equivalent cornering power ratio and the delay time constant ratio of the lateral force is calculated. In Equations (1) and (2), the lateral force of the wheels can be corrected with solely one of the equivalent cornering power ratio and the delay time constant ratio of the lateral force.

The corrected lateral force of the wheels can be substituted into the equations of motion of the following Equations (3), (4), and (5) to calculate the lateral acceleration y″, the angular velocity r′ of the yaw angle, and the angular velocity β′ of the slip angle at the center of gravity of the vehicle. Therefore, the vehicle motion to which the influence of the roll control gain is added is estimated.

$${y}^{″} = ( 2 {F}_{f} + 2 {F}_{r} ) / M \qquad Equation ( 3 )$$

$${r}^{′} = ( 2 {l}_{f} {F}_{f} - 2 {l}_{r} {F}_{r} ) / {I}_{z} \qquad Equation ( 4 )$$

$${β}^{′} = {y}^{″} / V - r$$

y is a lateral displacement of the center of gravity. M is a vehicle weight. I_{z} is an inertia moment of the center of gravity. r is a yaw angle.

The calculation unit 42 corrects the target steering angle such that the traveling state predicted based on the turning characteristic that is estimated matches the target position and the target yaw angle set on the target trajectory to calculate the target steering angle after the correction. The calculation unit 42 inputs the turning characteristic that is estimated, the vehicle speed, and the target steering angle before the correction to calculate the target steering angle after the correction. As a result, the turning deviation due to the roll control at the time of autonomous driving can be adjusted. The drive controller 36 controls the traveling device 18 in accordance with the target control value calculated by the calculation unit 42.

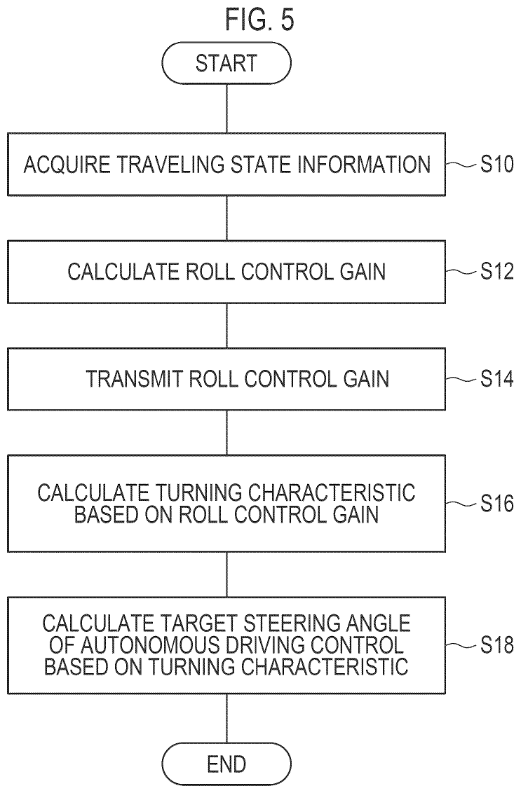

FIG. 5 is a flowchart of the vehicle control method of the embodiment. The acquisition unit 24 of the roll control device 20 acquires traveling state information, particularly the lateral acceleration of the vehicle body from the traveling state detection sensor 12 (S10). The gain calculation unit 26 calculates the roll control gain based on the lateral acceleration to suppress the movement of the vehicle body in the roll direction (S12). The communication unit 30 transmits the roll control gain that is calculated to the driving control device 22 (S14).

The estimation unit 34 of the driving control device 22 estimates the turning characteristic of the vehicle in accordance with the roll control gain that is acquired, specifically, the equivalent cornering power ratio and the delay time constant ratio of the lateral force (S16). The calculation unit 42 calculates the target steering angle to be executed in the autonomous driving control based on the turning characteristic that is estimated (S18).

The present disclosure has been described based on the embodiments. The present disclosure is not limited to the embodiments described above, and can be modified as various design changes and the like based on the knowledge of those skilled in the art.

In the embodiment, the aspect in which the estimation unit 34 is provided in the driving control device 22 has been described, but the present disclosure is not limited to the aspect, and the estimation unit 34 may be provided in the roll control device 20. In the aspect, the roll control device 20 estimates the turning characteristic of the vehicle in accordance with the roll control gain, and transmits the estimated turning characteristic to the driving control device 22.

What is claimed is:

1. A vehicle control apparatus that controls a vehicle behavior control device that is able to control a movement of a vehicle body in a roll direction, the vehicle control apparatus comprising:
an acquisition unit configured to acquire information indicating a roll control gain for driving the vehicle behavior control device to move the vehicle body in the roll direction; and
a calculation unit configured to calculate, when autonomous driving control is being executed, a target control value to be executed in the autonomous driving control based on the information indicating the roll control gain.

2. The vehicle control apparatus according to claim 1, further comprising an estimation unit configured to estimate a turning characteristic of a vehicle in accordance with the roll control gain, wherein the calculation unit calculates a target steering angle to be executed in the autonomous driving control based on the estimated turning characteristic.

3. The vehicle control apparatus according to claim 2, wherein the estimation unit estimates, as the turning characteristic, at least one of an equivalent cornering power of the vehicle behavior control device with respect to the roll control gain and a delay time constant of a lateral force with respect to the roll control gain.

4. The vehicle control apparatus according to claim 3, wherein:
the estimation unit estimates the equivalent cornering power of the vehicle behavior control device in accordance with the roll control gain based on information indicating a relationship between the roll control gain and the equivalent cornering power, the information being stored in advance; and
the information indicating the relationship between the roll control gain and the equivalent cornering power is a relationship in which the equivalent cornering power decreases as the roll control gain increases a magnitude of tilting the vehicle body toward an outer side of turning.

5. A vehicle control method executed by a vehicle control apparatus that controls a vehicle behavior control device that is able to control a movement of a vehicle body in a roll direction, the vehicle control method comprising:
acquiring information indicating a roll control gain for driving the vehicle behavior control device to move the vehicle body in the roll direction; and
calculating, when autonomous driving control is being executed, a target control value to be executed in the autonomous driving control based on the roll control gain that is acquired.
